(19) United States
(12) Patent Application Publication
(10) Pub. No.: US 2026/0215899 A1
(43) Pub. Date: Jul. 30, 2026

(54) SUCTION-BASED RECEPTACLE

(71) Applicant: Adnan Ahmed, Perrysburg, OH (US)

(72) Inventor: Adnan Ahmed, Perrysburg, OH (US)

(21) Appl. No.: 19/460,164

(22) Filed: Jan. 26, 2026

Related U.S. Application Data
(60) Provisional application No. 63/750,320, filed on Jan. 28, 2025.

(51) Int. Cl. A61C 17/06

(52) U.S. Cl. CPC A61C 17/065

(57) ABSTRACT

Methods, systems, and apparatus are provided for use in performing dental procedures. An apparatus includes a body having a funnel-shape; a surface coupled to the body, the surface having a plurality of openings; a support element coupled to a lower section of the body and configured to couple to a connector associated with a vacuum source; and a passage that extends through the support element and the body to the plurality of openings of the surface, the passage is configured to facilitate the flow of at least one of vapors, fluids, and particles therethrough when connected to the connector associated with the vacuum source.

### CROSS REFERENCE TO RELATED APPLICATIONS

This application claims the benefit of U.S. Provisional Application No. 63/750,320, filed January 28, 2025, which is hereby incorporated by reference in its entirety.

### INTRODUCTION

The technical field generally relates to apparatuses, methods, and systems to assist a dentist during a dental procedure, and more particularly relates to a suction-based receptacle for use in a dental procedure.

Dental professionals perform many tasks that can result in the formation of vapors, mists, droplets, and particles. Non-limiting examples of dental tasks forming vapors, mists, droplets, and particles include cleaning, shaping, and fitting of crowns, temporary appliances, and dentures. The vapors, mists, droplets, and particles can contain saliva and blood from the patient and can expose the dental professional to cross-contamination with hazardous microorganisms.

In certain instances, the vapors, mists, droplets, and particles can become airborne as the result of the interaction of compressed fluids, such as the nonlimiting examples of air or water, with a dental fixture, such as for example a denture. In other instances, the vapors, mists, droplets, and particles can be located on or adjacent a surface.

To lessen the likelihood of cross-contamination with hazardous microorganisms, it would be advantageous if the vapors, mists, droplets, and particles could be captured and conveyed away from the dental professionals.

Accordingly, it is desirable to provide improved methods, systems, and apparatuses for use in dental procedures. Furthermore, other desirable features and characteristics of the present invention will become apparent from the subsequent detailed description and

the appended claims, taken in conjunction with the accompanying drawings and the foregoing technical field and background.

### SUMMARY

Methods, systems, and apparatuses are provided for use in performing dental procedures. In one embodiment, an apparatus includes a body having a funnel-shape; a surface coupled to the body, the surface having a plurality of openings; a support element coupled to a lower section of the body and configured to couple to a connector associated with a vacuum source; and a passage that extends through the support element and the body to the plurality of openings of the surface, the passage is configured to facilitate the flow of at least one of vapors, fluids, and particles therethrough when connected to the connector associated with the vacuum source.

In an embodiment, the surface is integrally formed with the body.

In an embodiment, the surface is defined by a first angular rim that has a first segment configured to extend upwardly.

In an embodiment, the first segment is configured to extend upwardly from a second segment, wherein the second segment includes the plurality of openings.

In an embodiment, the surface is separately formed and secured into the body.

In an embodiment, the surface is secured into the body at a depth of the body associated with a circumference of the body that matches a circumference of the surface.

In an embodiment, the surface is substantially flat.

In an embodiment, the surface is partially funnel shaped.

In an embodiment, the surface comprises at least one connector extending from the surface to secure the surface to the body.

In an embodiment, the body comprises at least one of holes and indentations that receive the at least one connector to secure the surface to the body.

In an embodiment, the surface is formed with a metal material.

In an embodiment, the surface is formed with a polymeric material.

In an embodiment, each of the plurality of openings is at least one of round, square, hexagonal, slotted, diamond, ornamental, or a combination thereof.

In an embodiment, each of the plurality of openings is of a size smaller than a size of an average tooth.

In yet another embodiment, a system for providing dental services includes: a vacuum source; a hose configured to extend from the vacuum source and having a connector; a receptacle configured to couple to the connector and comprising: a body having a funnel shape; a surface coupled to the body, the surface having a plurality of openings; a support element coupled to a lower section of the body and configured to couple to a connector associated with a vacuum source; and a passage that extends through the support element and the body to the plurality of openings of the surface, the passage is configured to facilitate the flow of at least one of vapors, fluids, and particles therethrough when connected to the connector associated with the vacuum source.

In an embodiment, the surface is integrally formed with the body.

In an embodiment, the surface is defined by a first angular rim that has a first segment configured to extend upwardly.

In an embodiment, the first segment is configured to extend upwardly from a second segment, wherein the second segment includes the plurality of openings.

In an embodiment, the surface is separately formed and secured into the body.

In yet another embodiment, a method for using an apparatus for a dental procedure includes: coupling a receptacle to a suction source. Thee receptacle comprises: a body having a funnel shape; a surface coupled to the body, the surface having a plurality of openings; a support element coupled to a lower section of the body and configured to couple to a connector associated with a vacuum source; and a passage that extends through the support element and the body to the plurality of openings of the surface. The method further includes capturing via a negative pressure of the suction source, at least one of vapors, fluids, and particles through the passage.

### BRIEF DESCRIPTION OF THE DRAWINGS

The exemplary embodiments will hereinafter be described in conjunction with the following drawing figures, wherein like numerals denote like elements, and wherein:

FIG. 1 is dental tools system that includes a suction-based receptacle in accordance with various embodiments;

FIG. 2 is a side perspective view of a suction-based receptacle in accordance with various embodiments;

FIGS. 3 and 4 are top-down views of surfaces of a suction-based receptacle in accordance with various embodiments; and

FIG. 5 is a side perspective view of a suction-based receptacle in use in connection with a suction device in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

Methods, systems, and apparatuses including a suction-based receptacle will now be described with reference to various embodiments. The suction-based receptacle may, however, be embodied in different forms and should not be construed as limited to the embodiments set forth herein. Rather, these embodiments are provided so that this disclosure will be thorough and complete, and will fully convey the scope of thesuction-based receptacle to those skilled in the art.

Unless otherwise defined, all technical and scientific terms used herein have the same meaning as commonly understood by one of ordinary skill in the art to which the suction-based receptacle belongs. The terminology used in the description of the suction-based receptacle herein is for describing particular embodiments only and is not intended to be limiting of the suction-based receptacle. As used herein, the singular forms “a,” “an,” and “the” are intended to include the plural forms as well, unless the context clearly indicates otherwise.

Unless otherwise indicated, all numbers expressing quantities of dimensions such as length, width, height, and so forth as used in the specification and claims are to be understood as being modified in all instances by the term“about.” Accordingly, unless otherwise indicated, the numerical properties set forth in the specification and claims are approximations that may vary depending on the desired properties sought to be obtained in embodiments of a suction-based receptacle. Notwithstanding that the numerical ranges and parameters setting forth the broad scope of a suction-based receptacle are approximations, the numerical values set forth in the specific examples are reported as precisely as possible. Any numerical values, however, inherently contain certain errors necessarily resulting from error found in their respective measurements.

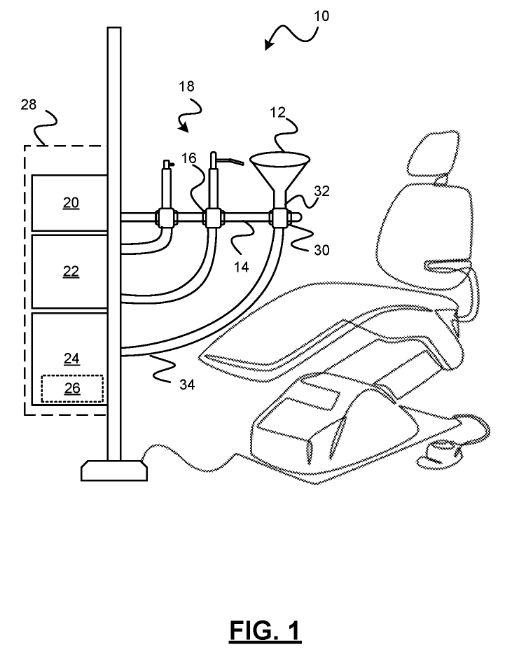

With reference now to FIG. 1, a system 10 for use when performing a dental procedure is provided having a suction-based receptacle 12 in accordance with various embodiments. The system 10 includes a tool holder 14 having one or more cut-outs 16 configured to receive and store one or more dental tools 18. Such tools 18 can include, but are not limited to, drills, sanders, polishers, air, gas, or fluid supply tools, suction straws, etc. The tools 18 can be coupled to a power source 20, a fluid, gas, or air supply source 22, and/or a suction source 24 of a dental unit 28 via hoses, electrical wires or cords, etc. In various embodiments, the suction source 24 includes a reservoir 26 configured to store captured vapors, mists, droplets, and/or particles received from a hose 34.

In various embodiments, the suction-based receptacle 12 as described herein couples to a connector 30 associated with the hose 34 associated with the suction source 24. For example, an inlet 32 of the connector 30 receives a first end of the receptacle 12 such that the receptacle 12 is secured in a substantially vertical, upright position when resting in the tool holder 14. The first end of the receptacle 12 is configured to be inserted (e.g., by pressure fit), screwed, or otherwise tightly secured within the connector 30 such that no vapor, fluids, or particles can be released at the connection point.

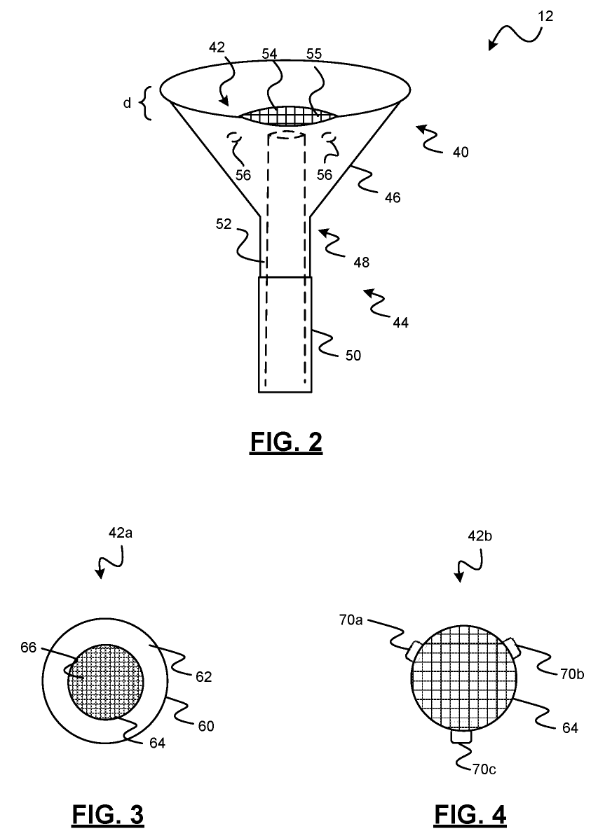

As will be described in more detail with regards to FIGS. 2-5, the receptacle 12, when in the substantially vertical position, is configured to capture the vapors, mists, droplets and particles formed during dental procedures and convey the vapors, mists, droplets and particles away from the dental professionals to the reservoir 26. As can be appreciated, the captured and conveyed vapors, mists, droplets, and particles can be airborne or surface borne.

With particular reference to FIGS. 2-4, the receptacle 12 is shown in accordance with various embodiments. Generally, the receptacle 12 includes a body 40, a surface 42, and a support element 44. The body 40 is generally funnel shaped and defined by a circumferential sidewall 46. A lower portion 48 of the body 12 is connected to the support element 44.

A portion 50 of the support element 44 is configured to be inserted into the inlet 32 (FIG. 1) of the connector 30 (FIG. 1) associated with the vacuum source 24 (FIG. 1) as described above. The support element 44 is hollow and/or tubular, which creates a passage 52 that extends from the surface 42, through the body 40 and the support element 44 to the connector 30 (FIG. 1). An inlet 54 is formed at an intersection of the passage 52 with the surface 42.

In various embodiments, the support element 44 is integrally formed with the funnel-shaped body 40. In various other embodiments, the support element 44 is attachable to the funnel-shaped body 40.

In various embodiments, the surface 42 includes a plurality of openings 55. The openings 55 can be any shape including round, square, hexagonal, slotted, diamond, ornamental, or a combination thereof and according to a pattern that maximizes the flow of the vapors, mists, droplets, and/or particles through the inlet 54 of the passage 52. The openings 55 are selectively sized such that common dental elements such as a tooth, a crown, or other tool will not pass through the openings 55. For example, the openings 55 are a size smaller than the size of an average tooth.

In various embodiments, the surface 42 is integrally formed with the funnel-shaped body 40. In various other embodiments, the surface 42 is separately formed and attached to the funnel-shaped body 40.

In various embodiments as shown in FIG. 3, an exemplary surface 42a of the receptacle 12 is defined by a first angular rim 60 that defines an upwardly projecting segment 62 and a second angular rim 64 that defines an opening segment 66. The second angular rim 64 has a circumference that is smaller than the first angular rim 60. The upwardly projecting segment 62 is configured to retain and direct fluids, vapors, particles, etc. towards the opening segment 66 of the surface 42a.

In the illustrated embodiment, the second angular rim 64 forms the shape of a cross-sectional shape of a circle. However, in other embodiments, the second angular rim 64 can form other desired shapes. In the illustrated embodiment, the first angular rim 60 forms the shape of a cross-sectional shape of a circle that matches the shape of the body 40. However, in other embodiments, the first angular rim 60 can form other desired shapes and the upwardly projecting segment 62 can have other forms sufficient to retain and direct fluids to the opening segment 66.

In various embodiments, the surface 42a is inserted into the body 40 at a depth (d) where a circumference of the body 40 and a circumference of the first angular rim 60 are substantially similar. In various other embodiments, the upwardly projecting segment 62 can be formed by the body 40 and the surface 42 is inserted into the body 40 at a depth (d) where a circumference of the body 40 and a circumference of the second angular rim 64 are substantially similar.

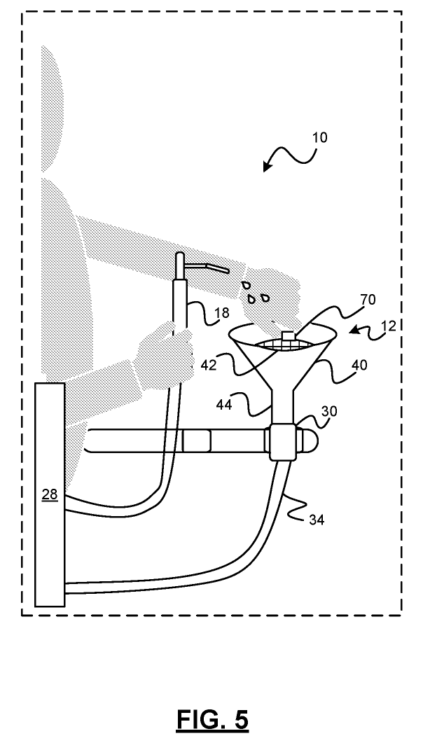

In various embodiments as shown in FIG. 4, an exemplary surface 42b includes one or more fastening devices 70a, 70b, 70c, such as winglets or tabs. As shown, in various embodiments, the fastening devices 70a, 70b, 70c extend from the second angular rim 64 when the upwardly projecting segment is not present or formed by the body 40. In various other embodiments, the fastening devices 70a, 70b, 70c extend from the first angular rim 60 (not shown in FIG. 3 where the upwardly projecting segment is present). The fastening devices 70a, 70b, 70c are configured to secure to indentations or holes 56 within the body 40 at the depth (d) to further secure the surface 42 to the body 40. As can be appreciated by one skilled in the art, other techniques of integrating the surface 42 and the body 40 are contemplated in accordance with various embodiments.

Referring again to FIGS. 2-4, in various embodiments, all or parts of the receptacle 12 is formed from a medical-grade polymeric material. The use of the medical grade polymeric material is configured to provide non-ionic, inert surfaces that minimize denaturation, agglomeration, and delamination and provide for repeated sterilization via all common methods. The use of medical grade polymer also advantageously provides extremely low leachables and extractables. One non-limiting example of suitable medical grade polymeric material is cyclic olefin copolymers (also known as “COC”).

In various embodiments, all or parts of the receptacle 12 is formed from a medical-grade metal, such as stainless steel (i.e., 304, 316, 216L) or titanium chosen for exceptional biocompatibility, superior corrosion resistance, strength, and the ability to withstand harsh sterilization (autoclaving) without degrading or reacting with dental or medical fluids. In still other various embodiments, parts of the receptacle 12 are formed of the medical grade polymeric material while other parts of the receptacle 12 are formed from medical-grade metal.

Referring now to FIG. 5 and with continued reference to FIGS. 1-4, the receptacle 12 is shown in use in accordance with various embodiments. As described above, the support element 44 of the receptacle 10 is attached to the connector 30 of the hose 34 in a manner such as to facilitate fluid communication between the inlet 54 (FIG. 2), the passage 52 (FIG. 2) within the body 40, and through to the hose 34. In operation, the hose 34 is fluidly connected to the vacuum source 24, such as a source of negative pressure. The source of negative pressure is such to convey the resulting negative pressure through the hose 34, through the passage 52 (FIG. 2) in the support element 44 and the body 40 and through the inlet 54 (FIG. 2). As a result of the negative pressure extending from the inlet 54 (FIG. 2), airborne or surface borne vapors, mists, droplets and particles formed during dental procedures and adjacent the inlet 54 (FIG. 2) are captured by the negative pressure and are conveyed through the 54 (FIG. 2) and through the passage 54 (FIG. 2). Accordingly and advantageously, the captured and conveyed airborne or surface borne vapors, mists, droplets and particles are moved away from the nearby dental professionals.

Referring again to FIG. 5, a dental crown 70 is seated or held by a dental professional near the surface 42 and adjacent to the inlet 54. It is contemplated the dental crown 70 can be cleaned, shaped and/or fitted with the use of dental tools 18 incorporating compressed fluids, such as the non-limiting examples of air and water, and/or dental tools incorporating grinding, milling, and sanding tools. The use of the dental tools 18 can result in airborne or surface borne vapors, mists, droplets, and particles. Advantageously, the use of the suction-based receptacle 12 and the suction-based negative pressures facilitate substantial removal of the airborne or surface borne vapors, mists, droplets, and particles as described above.

In accordance with the provisions of the patent statutes, the principle and mode of operation of the suction-based receptacle have been explained and illustrated in certain embodiments. However, it must be understood that the suction-based receptacle may be practiced otherwise than as specifically explained and illustrated without departing from its spirit or scope.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A dental tool apparatus, comprising:
a body having a funnel-shape;
a surface coupled to the body, the surface having a plurality of openings;
a support element coupled to a lower section of the body and configured to couple to a connector associated with a vacuum source; and
a passage that extends through the support element and the body to the plurality of openings of the surface, the passage is configured to facilitate the flow of at least one of vapors, fluids, and particles therethrough when connected to the connector associated with the vacuum source.

2. The dental tool apparatus of claim 1, wherein the surface is integrally formed with the body.

3. The dental tool apparatus of claim 1, wherein the surface is defined by a first angular rim that has a first segment configured to extend upwardly.

4. The dental tool apparatus of claim 3, wherein the first segment is configured to extend upwardly from a second segment, wherein the second segment includes the plurality of openings.

5. The dental tool apparatus of claim 1, wherein the surface is separately formed and secured into the body.

6. The dental tool apparatus of claim 5, wherein the surface is secured into the body at a depth of the body associated with a circumference of the body that matches a circumference of the surface.

7. The method of claim 5, wherein the surface is substantially flat.

8. The method of claim 5 wherein the surface is partially funnel shaped.

9. The dental tool apparatus of claim 5, wherein the surface comprises at least one connector extending from the surface to secure the surface to the body.

10. The dental tool apparatus of claim 9, wherein the body comprises at least one of holes and indentations that receive the at least one connector to secure the surface to the body.

11. The dental tool apparatus of claim 1, wherein the surface is formed with a metal material.

12. The dental surface apparatus of claim 1, wherein the surface is formed with a polymeric material.

13. The dental tool of claim 1, wherein each of the plurality of openings is at least one of round, square, hexagonal, slotted, diamond, ornamental, or a combination thereof.

14. The dental tool of claim 1, wherein each of the plurality of openings is of a size smaller than a size of an average tooth.

15. A system for providing dental services, comprising:
a vacuum source;
a hose configured to extend from the vacuum source and having a connector;
a receptacle configured to couple to the connector and comprising:
a body having a funnel shape;
a surface coupled to the body, the surface having a plurality of openings;
a support element coupled to a lower section of the body and configured to couple to a connector associated with a vacuum source; and
a passage that extends through the support element and the body to the plurality of openings of the surface, the passage is configured to facilitate the flow of at least one of vapors, fluids, and particles therethrough when connected to the connector associated with the vacuum source.

16. The system of claim 15, wherein the surface is integrally formed with the body.

17. The system of claim 15, wherein the surface is defined by a first angular rim that has a first segment configured to extend upwardly.

18. The system of claim 17, wherein the first segment is configured to extend upwardly from a second segment, wherein the second segment includes the plurality of openings.

19. The system of claim 15, wherein the surface is separately formed and secured into the body.

20. A method for using an apparatus for a dental procedure, comprising:
coupling a receptacle to a suction source, wherein the receptacle comprises:
a body having a funnel shape;
a surface coupled to the body, the surface having a plurality of openings;
a support element coupled to a lower section of the body and configured to couple to a connector associated with a vacuum source; and
a passage that extends through the support element and the body to the plurality of openings of the surface; and
capturing via a negative pressure of the suction source, at least one of vapors, fluids, and particles through the passage.
